(19) United States
(12) Patent Application Publication
(10) Pub. No.: US 2018/0158065 A1
(43) Pub. Date: Jun. 7, 2018

(54) SECURE AUTOMATED PAYMENT SYSTEM

(71) Applicant: Jeffrey Greenstein, Los Angeles, CA (US)

(72) Inventor: Jeffrey Greenstein, Los Angeles, CA (US)

(21) Appl. No.: 15/572,690

(22) PCT Filed: May 11, 2016
(86) PCT No.: PCT/US16/31721

§ 371 Date: Nov. 8, 2017

Related U.S. Application Data
(60) Provisional application No. 62/159,446, filed on May 11, 2015.

(51) Int. Cl. G06Q 20/40; G06Q 20/14; G06F 17/30; G06K 9/00; G06K 9/20; G06K 9/62; G06K 9/78

(52) U.S. Cl. CPC G06Q 20/40145; G06Q 20/145; G06F 17/30867; G06F 17/30256; G06K 9/78; G06K 9/00885; G06K 9/209; G06K 9/6201; G06K 9/00201

(57) ABSTRACT

The present invention is directed to a system and method for automated identification and authentication of individuals, delivery of goods and/or services to individuals, and payment for automated payment of said goods

This application claims priority to U.S. Provisional Patent Application No. 62/159,446, filed May 11, 2015, now pending, and incorporated herein by reference.

### FIELD OF THE INVENTION

The present invention is directed to a system and method for automated identification and authentication of individuals, delivery of goods and/or services to individuals, and payment for automated payment of said goods and/or services based on the individual.

### BACKGROUND OF THE PRESENT INVENTION

Certain types of goods or services are typically billed on an individual-by-individual basis. For example, each person who attends a movie at a theater or sporting event at an arena receives his or her own ticket based on the fee for that individual. However, recent advances in technology cause such billing models to be less functional, thereby creating a revenue reduction for the supplier. For example, the payment scheme at a movie theater or at a prize fight is based on the individual—each attendee pays a fee. But movies may now be delivered over the internet on a pay-per-view basis and, in that circumstance, billing presently is based on a single delivery of product, not based on the number of attendees. There has been no way to remotely determine the number of attendees. If, for example, the recipient has a room filled with a dozen or more people for viewing a movie, a single download fee would be charged, the movie provider has no knowledge of the quantity of viewers in the room, and there is therefore a potential loss of revenue for the movie provider.

Conversely, if movie delivery fees were based on the number of attendees, receipts could rise and people may find viewing events at home as being more economical. Movies and other pay-per-view events that are delivered now on a per showing basis but could be delivered based on the number of watchers, not the number of downloads.

As such, it would be beneficial to implement a system and method whereby people can be identified and charged individually in an automated way so as to increase revenue to the distributor.

Technology presently exists for identifying people yet has not been implemented in any kind of automated way to serve further functionality. For example, fingerprint scanners exist, but a system and method of billing individuals based on a fingerprint determination of their presence in a room has not been developed or implemented.

Other forms of scanning for a person's identity also exist but they have not been used for billing purposes either. For example, voice recognition capability has improved in recent years, and some applications have been developed based on voice recognition, however, none is used for specifically identifying all individuals in a room and billing for a service delivered to the room. Similarly, voice recognition can be used to identify individuals, but each individual is not billed based on recognizing the individual's voice.

Similarly, facial recognition technology has also improved but has not been used in a manner similar to the one described above.

The implementation of such a personal identification process can be used for more than just billing. It can be used as a check relative to anti-piracy, such as by providing identification of the purchaser so that a purchase is assured (without being limited to purchases based on a credit card number). Again, lost revenue is a significant issue, such as through piracy or theft, and an invention that assures a person is who he/she asserts he/she is, can improve lost revenue; and serve as an aid in combating identity theft.

Once the individual is identified, it would be beneficial that the individual's preferences may also be identified, such as the person's interest in a variety of goods and services and how the person wishes to receive certain goods and services and to associate the recognized with their preferences. Some goods may be delivered to the individual's smart phone and other goods to the individual's house, and the delivery selection may be based on the individual's preference. For example, an individual who attends a concert may be interested in automatic downloads of recordings by the artist. Preference could also include billing and payment preferences.

Fraud is a growing problem with respect to ticketing transactions and on-line or mobile phone transactions. There are frequent media reports of attendees at sporting events and theaters being denied entry because others hold tickets with, for example, the same scanned bar code. In recent times, such as for select sporting events, requirements to have a paper ticket have been employed which limits the ability for resale or redistribution. In at least some cases, purchasers view at least some of these requirements as excessively onerous. It would be beneficial to both the ticket holder and the event if there was a way to validate that a ticket holder is the proper ticket holder in a less onerous way.

It is a goal of the present invention to identify and authenticate individuals so as to assure each individual is properly billed in an automated way, preferably in line with the individual's desires for paying, for each purchased good or service.

It is a goal of the present invention to use an automated determination of identity to match to known information about the individual. It is a further goal to facilitate delivery of goods and services which are of interest to an individual and a goal to deliver them in a presubscribed manner preferred by the individual at the time the individual expresses interest.

It is also a goal of the present invention to provide an automated anti-piracy and anti-identity theft approach to financial transactions.

### BRIEF DESCRIPTION OF THE PRESENT INVENTION

The present invention meets the aforementioned goals and is directed to a system and method for delivering services and/or goods to a group of individuals or to particular individuals with payment based on automated identification of individuals. By identifying people individually or by identifying the quantity of people in a room, the present invention facilitates billing for a service, such as delivery of a movie or sporting event, based on a per-head basis. The present invention facilitates billing people individually and/or billing a host based on the number of people in a room or based on billing the host for otherwise unbillable attendees.

In addition, in the system and method of the present invention, data regarding one or more physical characteristics of an individual are captured and stored and used for matching a person in the room to the profile of a known individual. Product preferences may also be stored, including delivery preferences.

The present invention is beneficial in many ways, including improving revenue streams for buyers/distributors, theatre chains, concert promoters and venues, and retailers and improving delivery options for consumers.

### DESCRIPTION OF THE FIGURES

FIG. 1 depicts a schematic diagram of the major components of the system of the present invention.

FIG. 2 depicts a flow chart of the steps of the present invention.

### DETAILED DESCRIPTION OF THE PRESENT INVENTION

The present invention is particularly directed to delivering goods and/or services, and billing for those goods or services based on automated recognition of individuals, recognized through at least one physical attribute of the individual, such as a physical attribute or audible attribute which can be used to uniquely identify the individual or based on the individual's belongings. In an exemplary embodiment, the system and method of the present invention may be used to count patrons at, for example, a movie screening, a type of transport, or another event in which a capacity-limited slot is taken, or some other multi-person attending event, identify the patrons individually through a scan of the person and a comparison to previously obtained data, bill them directly (or confirm billing) in some known manner, such as individually or paid by the host, and screen the movie (or deliver the event) subsequently to all patrons being billed. This described method, like other methods described herein, may be accomplished automatically.

The ability of the present invention to individually identify people based on physical attributes affords the opportunity to avoid use of passwords as identifiers (or, alternatively, passwords can be used to supplement identification means) and can limit the likelihood of fraud. As such the present invention is further directed to automated identification of individuals based on one or more physical characteristics, such as, but not limited to, facial appearance, body type, hair characteristics including color, eye color, retina, fingerprint, or voice.

To overcome the issue of fraud, the present invention employs any number of authentication means so as to assure that the proper person is associated with a ticket and/or billing information.

The present invention also affords a variety of interrelated means for individually identifying people. Because the system of the present invention includes a database (data store) with content related to individuals, an individual can be identified by matching, automatically, either by the physical characteristics described above or through a device that may be in the presence of the person or some combination (in addition to the password discussion above). For example, an individual may be identifiable through a hand held device, such as a smart phone or tablet computer, or through a device with an embedded transponder. A credit card or a passport, for example, could be embedded with a transponding-like element and, together with facial recognition, could be used to automatically identify the individual in either or both of two ways. In at least some embodiments of the present invention, dual forms of identification could be required.

As a general overview of aspects of the present invention, the present invention preferably includes a “central” system and a “remote” system, which communicate with each other, such as over the Internet. The remote system includes a remote media receiving device, such as a server or a cable box, which is integrated with one or more devices for identification purposes. The remote system of the present invention may also preferably include a point-of-sale device and a device with the ability to play media files. This remote system may not necessarily all be housed in one unit. The identification device could be, for example, one or more cameras, a voice recognition system, or a retina reader.

The central system includes at least a processor and a data store. The data store preferably comprises data usable for confirming identity of individuals and preferences for individuals. For example, the data store could include information regarding individuals, such as facial features, voice features, finger print features, or some combination, stored in a digital form and, for privacy purposes, encoded in some way. The data store, arranged by individual, could also include user preference data, such as preferred size of clothing, preferred colors, favorite artists, information regarding associated mobile devices, preferred credit card, and credit card information, all stored in a secure environment.

In a preferred embodiment, suppose a plurality of individuals wishes to attend an event, such as a movie screening. The present system would allow for charging a per head fee for the viewing. As each individual enters a facility where a purchase is required, such as a movie screening room (or alternatively during a point in time of the showing), some device in that room is used to capture identifying information about each individual. In the preferred embodiment, the device is one or more cameras usable to capture a person's likeness, either as an image or video, capturable to form a 2D or 3D image, but could alternatively be related to a device carried by the individual (such as a cell phone), which could be programmed to emit or deliver a code directed to a receiving device, where the code is usable for authentication. The cameras could be distributed so as to obtain concurrent images from different perspectives. The images could be still or moving, but in aggregate are used to obtain enough data for identification purposes. The in-room device arranges for a communication channel to a server in communication with the data store. The server could be cloud-based. The device delivers digitized identifying information, preferably encoded, to a processor at the server, preferably at the central system, which is programmed to run comparisons with data in the data store. That is, information about each person's identity is sent to the central system.

Upon matching a profile in the data store, the server may request and/or receive further confirmation so as to improve confidence in the identity of the individual, such as by use of further identifying physical attributes or otherwise. For example, the processor may return a message saying “I believe you are John Jones; please place a fingerprint on the pad below to confirm.” This identifying information may be specific to the individual, or specific to a device carried by the individual, or some combination. For example, the processor may ask the device directly for identifying information. Alternatively, the system of the present invention may message (or email) the presumed user and ask for a code to be entered so as to confirm authenticity.

This identity confirmation approach can also be useful for fraud prevention. For example, an individual can purchase a ticket for an event on-line, such as for a movie or form of travel. The ticket can be stored electronically in the individual's account, which is accessible through a mobile device. Upon entering the event space, the individual can scan the phone so as to “retrieve” the ticket (or provide a printed version), and the purchaser can be further authenticated through facial recognition (or other recognition described herein).

Once the system of the present invention is assured of having identified an individual, preferences for that individual stored in the data store may be made available locally. For example, a local processor may be made aware of which credit card to bill and may be usable to suggest ancillary items customized to the individual's taste, such as offering T-shirts in a particular size.

The present invention is particularly beneficial with regard to streaming content. For example, an individual may want to screen a movie or sporting event or the like at home or another less public venue. In today's routine billing model, the individual now utilizes a pay-per-view model and pays a one-time pay-per-view fee to the production company's agent, such as a cable company, for the screening. This fee is independent of the number of viewers, thereby resulting in possible lost income to a production company, buyers/distributors, and theatre chains. To combat this lost revenue, the present invention allows for implementation of an automated by-head billing approach, with payment at the time of delivery, and paid for by someone with responsibility for payment.

In still other embodiments, individuals may be identified uniquely and attributes of the individual may also be identified, such as for delivery of goods. For example, a database regarding different individuals may be available. The database could include data regarding an individual's physical appearance, such that the data can be used for identification. The original date of the data needs to be kept as well in that the system of the present invention may need to make correction based on aging. Other demographic information regarding the person could also be included in the database, such as address, type of hand held device they carry, and payment information (such as credit card data).

It also is possible that once an individual's information is included in the database, they can be enrolled as “members”. Members in the context of the present invention may be entitled to select benefits.

Certainly from time to time, members (and others) can be queried to update the information on them in the database.

In other embodiments, other types of goods may also be delivered. For example, once an individual is known to the system of the present invention, options to purchase additional materials might become visible during a movie screening or at a screening of a sporting event, such as goods associated with the screening or advertisement shown during the sporting event. These goods can be automatically delivered, such as to a smart phone or through courier, based, for example, on the individual's stated preference.

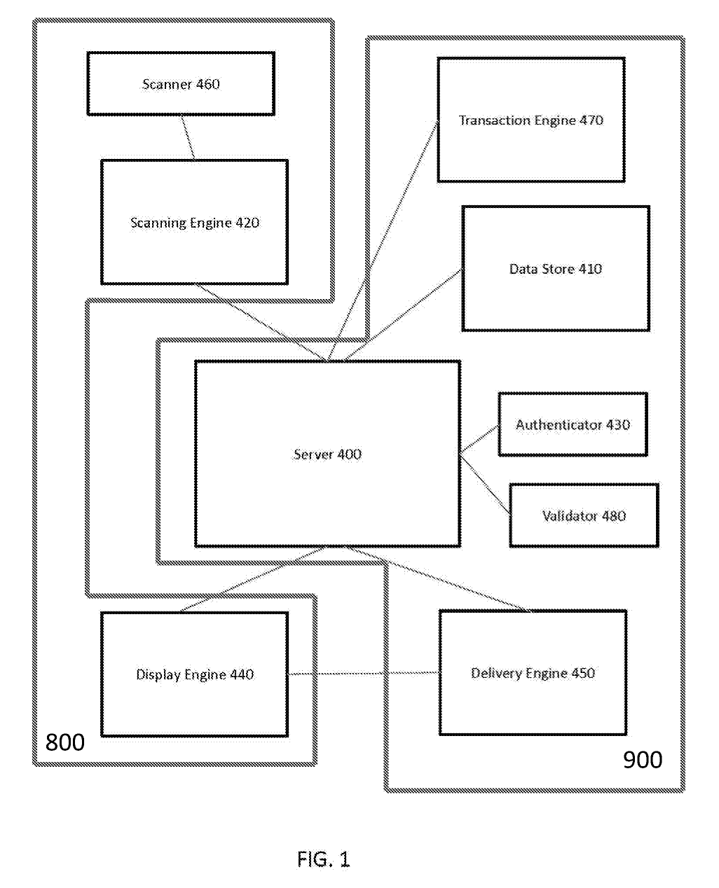

FIG. 1 depicts a schematic diagram of the more significant components of the system of the present invention. In general, although a component may be shown as a single component in FIG. 1, it is understood that each of these may in actually be a series of interconnected or interrelated components. It is also understood that although certain components are shown as separate from one another, such a depiction is illustrative in a schematic diagram only and various of the components can physically be combined if need be. As can be seen in FIG. 1, there preferably are two systems—a central system 900 encompassing much of the processing and identifying functions and a remote system 800 for receipt an delivery of data and content.

The system of the present invention is understood to include one or more processor-controlled servers which are programmed to receive data regarding an individual, determine if analogous data exist in a database, compare the received data to any analogous data to determine a match, and then utilize other entries related to the matched data so as to identify additional related attributes about the individual, such as billing data, information regarding delivery of goods and services, the type of communication device the individual may have in their possession, and data regarding personal preference. The system of the present invention also includes a database, which may be relational, and which may be configured as a collection of data stores.

As noted, the system of the present invention includes a variety of elements. These elements include at least a processor and a database. The processor of the present invention is programmed to accept data from another source, such as a camera; said camera being any of an ordinary camera, a thermal imaging camera, and infrared camera, or some combination, and use the data to determine matches in a database. For example, the data from the camera may be indicative of the image of a person and the processor can be programmed with facial recognition instructions to recognize attributes of a person and compare those attributes to people known through data in a database. In an embodiment, the database may contain further information regarding the person, such as stored billing information. In at least one embodiment, the elements may be coupled into a single device.

While described above as a single camera, a plurality of cameras can alternatively be used so as to obtain additional data better defining the person's physical attributes (for the purpose of identification). A processor can be programmed to combine images from different cameras so as to obtain a more definitive understanding of the person such as a 3D understanding.

As depicted in FIG. 1, a server 400 is shown as the core of the present invention. Server 400 is preferably web based and includes communications channels to a variety of other components, as shown in FIG. 1. Authenticator 430 is an engine programmed to determine if data regarding an individual matches known data regarding individuals so that a match can be determined. Data store 410 is accessible for reading and writing by server 400 and may be in the form of a relational database. Data store 410 preferably includes data regarding individuals, including data usable by Authenticator 430 for authenticating an individual. Validator 480, also shown, can serve as a checker on the results of Authenticator 430. For example, if an individual is authenticated, validator 480 can deliver an interactive check to assure that the individual indeed wishes to be billed. In such a validation, data store 410 may be relied upon for retaining such validation information on an individual-by-individual basis.

Scanning engine 420 is in communication with server 400 and one or more scanner 460. Scanners 460 are used to scan individuals or aspects of individuals so as to obtain data regarding each individual. Scanner 460 may be one or more facial scanners, retina scanners, voice scanners, or physical scanners (like fingerprint), each or all of which may deliver data to scanning engine 420 for capture and use by authenticator 430. Other forms of physical scanners could be scanners to identify hair color, race, eye color, skin color, or scanners to identify other combinations of physical appearance. In one embodiment, the individual can be provided with a device, such as a wristband, which emits one or more encoded frequencies and the scanner can scan for such encoded frequencies. In at least some embodiments, scanner 460 may be incorporated in another device, such as but not limited to a cable television box or a security system. Scanning engine 420 may be directed by server 400 to scan some combination of individuals in a room or scan one or more entry points to the room. Server 400 may direct scanning engine 420 or operate from time to time to assure, for example, that the number of people in the room has not changed.

Transaction engine 470 is used to interface with a merchant to bill individuals. Server 400 determines how prescribed billing should occur—e.g., each individual should be billed $5.00 for an event to be shown, and transaction engine 470 interacts with a merchant or financial institution, typically using a web-based connection, so as to complete billing in the manner prescribed. As noted herein, upon identifying an individual, data related to that individual, such as preferred billing, may also be made available. Transaction engine notifies server 400 of the successful transaction and server 400 tracks such successes so as to assure all present have a successful transaction accounted for.

In an example in which a number of people are present so as to attend a movie screening, once all present have a payment associated with them, server 400 notifies delivery engine 450 to deliver the goods or services. In the exemplary embodiment of the present invention, where a movie is to be displayed in a room, delivery engine interacts with any external element destined to deliver the goods or services, such as a distant movie studio, and delivery engine 450 receives the movie. Delivery engine 450 may deliver the movie directly to display engine 440 or it may deliver the movie via server 400. Display engine 440 then coordinates display of the movie, such as by interacting with a projector.

Billing for an event may be directed to individuals, the host, or some combination. Similarly, billing may be directed purely to the host with a head count determined and related items (T shirts, food, etc.) billed directly to individual consumers.

Once each individual is identified, the individual may be interested in receiving delivery of additional content, such as in the form of a notification in an app to a smart phone or computer. Once a transaction is established for delivery and once the individual is properly and securely identified, the content may be delivered automatically to the individual's device. In an alternate example, if the individual is at a screening of a movie, goods related to that movie may be purchased and delivered to the individual's home address.

In other embodiments, the ability to identify the individual can be useful in facilitating a variety of transactions or services, particularly those in which piracy has been of particular concern. By automatically identifying a person based on physical features, it becomes more challenging for a masquerader to falsely create the impression that he/she is the individual.

As an example, even if an individual receives an electronic ticket, some other form of authentication, such as visual ID, may be required.

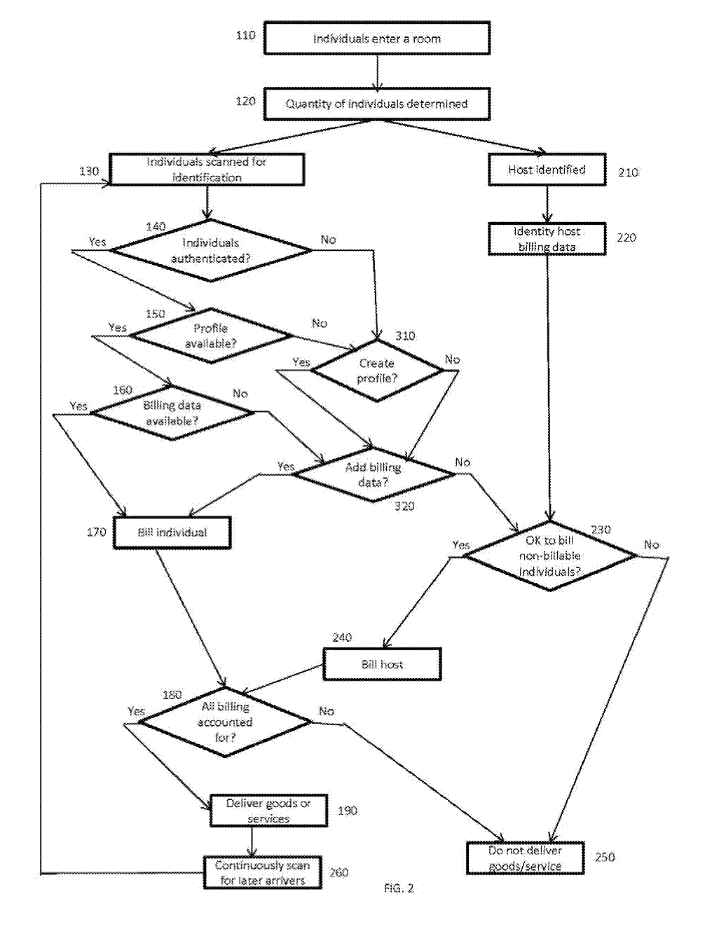

FIG. 2 depicts a flow chart of the method of the present invention. In the method of the present invention, individuals enter a room 120 in step 110. Once entered, the system of the present invention scans the room to determine the quantity of individuals in the room 120. Such a scan may be accomplished in one or more known ways, possibly in combination, such as but not limited to use of a camera to recognize individual bodies or faces, a temperature sensor, a monitor to monitor entry and exit from the room (such as with use of a camera to monitor pass through a doorway), some type of sign-in mechanism, some other sensor, or some other known way.

With reference to the right side of FIG. 2, in addition to determining the quantity of individuals, there is a need to identify the host of the event. As defined herein, the host is defined as the default person for billing. For example, if the event includes 50 individuals and unique and determinable profiles are only available for 30, the host would be responsible for payment for the remaining 20 individuals. For example, suppose the event was a movie screening. Each of the 50 patrons needed to have a payment made on their behalf. If 20 individuals have no automated means for payment, the remaining 30 patrons would be denied the ability to view the screening. However, if a “host” agreed to pay for the remaining people, then payment for all is accounted for and the event may proceed. Any or all of these thirty patrons could become “members” and have their profiles (identifying information, preferences, and so on) include in the stored data for use during the present event or later events.

As should be event, not all profile data may be available initially in the present system and new portions of profile data may be added by the user over time.

In step 210, the host is identified. Such identification may be through known techniques, such as query and response or some login procedure. Once the host is identified, the host billing data needs to be identified in step 220. The host billing data may be determined in any number of known ways, such as but not limited to direct entry of data or identification in a data store of billing data associated with the host. Validation may be included in this step if needed.

If the individual chooses not to add billing data or billing is otherwise unassigned to an individual in step 320, the absence of billing information for that individual is recorded, and the host would be given the option to pay for that individual in step 230.

In one embodiment, once a movie (or other downloadable content) is made available to a screening room for viewing, software used for downloading the movie can also be used for determining a head count and for establishing a payment means. The number of people in the room may be identified in several different ways. For example, one or more cameras may be mounted in a room and one or more images may be taken (at the same time or at different times). Images taken at different times can be used for averaging the number of people present, determining a maximum present, or, for example, implementation of an algorithm for payment (e.g., if the event includes two basketball games, there could be separate billing based on attendees per game). An image processor may be employed to examine the images and discern the presence of faces or structure of a person or the like from one image or a combination of images. This image processing can be used to determine the quantity of people in the room.

In another example, the number of people in the room can be determined based on some time-of-entry-requirement. For example, a person may need to provide a fingerprint, hand print, voice print, or the like to identify their presence in the room. The image processing approach detailed above can be used in conjunction with this proactive entry requirement for validation.

Importantly, such an approach can be used at present day theaters or other audience-fillable event to measure the number of people in the audience as well.

Once the number of people in the room is determined, individuals may be uniquely identified 130. This identification may be done in any of a number of ways. In one embodiment, each individual is identified using a camera which captures a processable image. In a variation of the embodiment multiple cameras may be used so as to form the equivalent of a three dimensional image. The image is used to perform facial recognition of the person. The processable image is used to match the person to known individuals, such as using data stored in a database.

In an alternative embodiment, an image of each individual may be taken and matching may be done using recognition of the face and body, possibly including hair (such as form and color combined).

In another embodiment, the individual may be recognized by the location of the individual's cell phone or another device with a location recognizable by GPS coordinates or equivalent. The system of the present invention can, for example, recognize all devices with certain ranges of GPS coordinates and a database of user attributes can be searched to associate devices in the ranges with individuals. Once recognized, the devices can be communicated to by the system of the present invention and the devices can be used to further authenticate users, such as by password entry or fingerprint recognition (in the event that the device is lost or stolen and being used by another person).

In still another alternative embodiment, scanning devices other than a camera could be used. That is, each unique individual may be identified using one or more of a voice scan, a fingerprint scan, a handwriting scan, a retinal scan, or some combination of any of these or the other approaches mentioned above.

Once each individual is identified, there may be an optional step 140 whereby one or more of the unique individuals' identities is authenticated. Such authentication may take any of several different forms. For example, each person may electronically be asked an authenticating question. Delivery of such a question may be to the individual's smart phone or at a computer station. Alternatively, another of the identification mechanisms discussed above may be used to authenticate.

Once the user is identified, the system of the present invention determines if the individual is independently known to the system. That is, in step 150, the system determines if a profile of the individual is available to it. If the profile is not available, the option to create such a profile is added in step 310. Such a profile could include various data regarding the individual, including any or all of facial and body features, characteristic data usable by facial recognition software, voice prints, finger prints, retina prints, text-based confirmatory data (such as question and answer), and billing data such as credit card information.

Whether the individual creates a profile or not, the individual is offered the opportunity to add billing data in step 320 to the profile or for the one time event. If the individual chooses to enter billing data and be billed for the event, the individual will be billed in step 170.

If the individual chooses not to add billing data in step 320, the absence of billing information for that individual is recorded, and the host would be given the option to pay for that individual in step 230. If the host elects to pay for non-billable individuals, the host would be billed for them in step 240.

Receipts may be delivered upon billing.

If the profile is available, there is a need to check to assure billing data is available in the profile in step 160. If the billing data for that individual is available, the person is billed in step 170.

An individual can establish preferences for billing and a profile can be established. Once an individual is identified and recognized by the system of the present invention, the established preferences for billing and profile can be utilized, potentially without the need for user actions (such as keypad entry, swipe, or even reaching for a card). Further, once the individual is recognized, the individual's preferences can be used for billing for a variety of services.

For example, suppose a user enters an establishment which serves alcohol and the prevailing law is that alcohol cannot be served to someone under a certain age. The user can be recognized upon entering the room and a determination can be made that the user is of age. The user attempts to purchase a drink and uses a fingerprint (or similar, or facial recognition yet again) to result in billing and payment by credit card. the drink is authorized and billing is automatic. The user's tipping preference could also be included in the profile and tipping can be automatic, and a receipt delivered to the user's email account of record. Such a process saves time and effort and also assures conformity to the user's desires.

Once the user is identified, the system of the present invention can communicate with the user, such as by email, messaging, phone call, or other known way, to obtain direct confirmation from the user that the present circumstance is permissible, where the circumstance might be on a transaction by transaction basis or might be for all transactions while the user remains in the room, or some other similar approach.

To facilitate subsequent transactions, a user's profile may be temporarily made available to an in-room access point so as to be usable for recognition and/or payment purposes so as not to need to form outside queries, which could take more time than otherwise needed.

In addition, once the user is recognized, the preferred method of payment may be used for additional sales in the location. For example, suppose the event is a movie. If the user wishes to purchase popcorn, a drink, or a souvenir, a point of sale terminal can be associated with a recognition device and may be used for payment. Again, recognition may be in the form of facial recognition, fingerprint, eye recognition, or the like.

Privacy of user information is significant in the present invention. While attributes and preferences of an individual appear to be delivered from one device to another, in the course of the present invention recognition data, such as data usable for facial recognition purposes are collected and encoded for delivery. In at least one embodiment of the present invention, the encoded data are compared with other encoded data, encoding using the same technique, so that, for example, actual finger print data cannot be recreated.

The present invention is usable as a means to combat fraud. In at least some situations, arenas and theaters use an encoding, such as a bar code, on a ticket and the ticket holder needs to scan the encoding for entry, with each possible seat having a different encoding. At times, it has been reported that different attendees bringing the same encoding thereby potentially allowing unauthorized ticket holders from entering. To combat this problem, the purchaser can be identified in a physical way (retina, facial, fingerprint, or voice recognition, as examples) at the time of purchase, and this same recognition would be needed in conjunction with the ticket at the time of entry. In an extension to this approach, the original purchaser can resell the ticket and authorize the system of the present invention to recognize the re-purchaser for entry. In other words, the present invention can be used to physically identify the proper individual with the ticket.

In at least some cases, one individual may be interested in paying for another. There may be an additional option step that the individual needs to authorize the payment, such as by clicking a box on their smart phone. For example, if the individual wants someone else to pay, that someone else could be notified and given the option to pay for the individual.

Alternatively, if the billing data is not available, the individual may be prompted to enter her/his billing data, which could be used for this particular transaction or could be added to the profile for later uses.

After billing, there is a check in 180 as to whether all individuals in the room are associated with a billing. If not, in step 250, the goods and/or services would not be delivered to the group. If yes, in step 190, the goods and/or services would be delivered to the group. Subsequently, continuous scanning in step 260 would check for late arrivals.

The system of the present invention can be applied to other methods related to the one described above. For example, a person could use the automated payment system of the present invention to advance purchase a virtual ticket to an event, e.g., a show, a concert, or some other live event. The ticket could then be stored in an account known to the system and related to that person, e.g., the person's ‘account.’ Then, when the person physically appears to attend the live event, the person could be scanned and the purchase of the ticket could be verified at the door, or the ticket could be accessed via a ‘mobile app’ where an e-ticket could be scanned at the door.

Another example includes a public venue, such as a pub, where a live event such as on a pay-per-view basis may be shown. Such a venue has the ability to charge a cover fee to offset pay-per-view costs, or such a charge may be required in an agreement between the public venue and the pay-per-view distributor. Using the system of the present invention, the venue could utilize the system's automated payment system and alternatively collect cash at the door for anyone not a member of the automated payment system in the role of host, thereby covering their transaction fee.

1-20. (canceled)

21. A method for a computer-based processor to bill individually for attendees of a pay streaming event, said event priced per attendee, said billing in consistency with preferred payment by each attendee, comprising the steps of:
identifying a host for a streaming event deliverable to a venue, said host determined based on an order for an event;
using an electronic biometric identification device recognizing at least one biometric attribute of each attendee at said event;
delivering a query to a data store directed to identifying preferred payment means for an attendee, said query including data indicating said at least one biometric attribute of said attendee; and
if said payment means is found in said data store, billing said attendee based on said attendee's preferred payment means, otherwise billing said host based on said host's preferred payment means, said host's preferred payment means determined based on at least one of said host and said delivery venue.

22. The method of claim 21, where said electronic biometric information is determined using a plurality of interconnected cameras to form a 3D image for facial recognition.

23. The method of claim 21, where said electronic biometric information is determined using means for sound or voice recognition.

24. The method of claim 21, where said electronic biometric information is determined using means for retina recognition.

25. The method of claim 21, where said electronic biometric information is determined using means for body recognition.

26. The method of claim 21, where said electronic biometric information is determined using means for finger print recognition.

27. The method of claim 21, further including the step of delivering media content upon confirmation of payment for all attendees.

28. The method of claim 21, where said host is further determined based on origination of a request to stream.

29. A system for individually billing by each attendee of a streamed media event including:
a computer-based processor;
at least one electronic biometric identification device;
a data store; and
a billing module, said billing module arranged for billing in consistency with known preferred payment by said individuals, said processor programmed to:
identify a host for a streaming media based on determining who ordered said event or a predetermined venue in a data store lookup;
identify the number of people in attendance at said event and at least one biometric attribute of each person attending, each based on data obtained from said electronic biometric identification device;
searching said data store so as to relate a person's biometric information to an individual and the individual to the individual's preferred payment means; and
if said payment means is found, billing each said person based on said payment means, otherwise billing said host based on said host's preferred payment means.

30. The system of claim 29, where said electronic biometric identification device includes at least one camera for facial recognition.

31. The system of claim 29, where said electronic biometric identification device includes means for sound or voice recognition.

32. The system of claim 29, where said electronic biometric identification device includes means for retina recognition.

33. The system of claim 29, where said electronic biometric identification device includes means for body recognition.

34. The system of claim 29, where said electronic biometric identification device includes means for finger print recognition.

35. The system of claim 29, said processor delivering media content upon confirmation of payment for all attendees.

36. A method for a computer-based processor in communication with a ticket scanner, an electronic identification device, and a data base, to determine authenticity of tickets for an entertainment event comprising the steps of:
electronically scanning a ticket for entry;
recognizing at least one biometric feature of a person in possession of said ticket using said electronic identification device;
searching a data base for a match between said feature and a person and between the person and said ticket; and
allowing entry of said person to said entertainment event only if there is a match between said ticket and said person and between said person and said recognized feature;
wherein said data base is populated with identification content of said ticket and an identifying feature of said person at the time of ticket purchase.

37. The method of claim 36, where said biometric feature is determined using a plurality of interconnected cameras to form a 3D image for facial recognition.

38. The method of claim 36, where said electronic identification device includes means for sound or voice recognition.

39. The method of claim 36, where said electronic identification device includes means for retina recognition.

40. The method of claim 36, where said electronic identification device includes means for body recognition.
